(19) United States
(12) Patent Application Publication
(10) Pub. No.: US 2004/0060944 A1
(43) Pub. Date: Apr. 1, 2004

(54) Theft deterring shelf aid dispensing device

(76) Inventor: Paul Gervasi, Kirkland (CA)

Correspondence Address: Francois Martineau, Lesperance & Martineau, 1440 ouest rue Ste-Catherine bureau 700, Montreal, QC, H3G 1R8, CA

(21) Appl. No.: 10/381,582

(22) PCT Filed: Sep. 30, 2002
(86) PCT No.: PCT/CA02/01489

(51) Int. Cl. B65H 3/00; G07F 11/16

(52) U.S. Cl. 221/263

(57) ABSTRACT

A display case having a plurality of compartments with a front covering closing them. A bottom slide dispenses one article at a time, from the bottom of each compartment. As the slide moves, it makes a loud noise to tell the store clerk that someone is dispensing a product. A would-be thief is thus placed on guard that his or her activity is being monitored by the check-out clerk, even if the thief is beyond the line of sight of the clerk.

### FIELD OF THE INVENTION

This invention relates to display devices for merchandise in retail stores, and more particularly to a device for giving a sound noise indication that an article of merchandise has been removed from the display device.

### BACKGROUND OF THE INVENTION

Before the 20^{th} century, it was customary for retail store clerks to receive their customers behind a customer counter, so that the customer would directly ask the clerk for such and such commercial goods. The clerk would personally get the requested goods, process the order and receive payment directly from the client. This was a straightforward way of doing business, but it was also a labour-intensive one.

Now, in the current market in at least North American and European commercial retail stores, a customer typically enters the premises freely and can immediately inspect and has immediate access to most of the commercial goods offered for sale, for example cigarettes, chewing gums, candy bars, and the like, without needing to previously personally contact a store clerk nor enter into a specific contract with the shop owner each times the customer comes in. Indeed, it is now common for store owners to allow customers to inspect, touch, handle or put into a wheeled cart any commercial article on display in the store, without intervention nor direct monitoring by the store owner or store clerks. It is presumed that good faith will be followed by most of the customers, reporting at the check out counter to account and pay for the commercial goods removed from the store shelves before leaving the store. It is believed by store operators that the increased volume of sales due to convenience to the customer, and decreased overhead costs due to lower labour requirements, has made such a modern commercial operation a more efficient one compared to the 19^{th} century system.

However, in the commercial retail business, “the shrinkage”, or percentage loss to shoplifters of unpaid commercial goods, is a growing preoccupation. Various ways of mitigating this problem have been developed, particularly in the last twenty years or so, to address this problem. One such solution is the installation of gates at the stores doors, with opto-electric sensors sensitive to markers embedded into the commercial goods. Another type of theft mitigation device is a type of ink clamp, used in particular in clothing stores, that will stain with ink, automatically or in a time deferred fashion, the piece of clothing if this piece of clothing is brought outside the store without proper official clearance. Another way of controlling shoplifting for small, low-cost items is to place them close to the check-out counter, so that the customer will be in the line of sight of the clerk at the counter, and thus should be deterred from attempting to perform shoplifting.

Such known theft mitigating solutions are used for large and/or expensive items, such as lounge suits or kitchen appliances, or for cheap items, but may not be deemed cost-effective for small items of intermediate cost such as cigarettes or razor deemed cost-effective for small items of intermediate cost such as cigarettes or razor blades. In fact, small but still somewhat relatively expensive articles, such as razor blade cartridges, are more and more the target of shoplifters, since these articles can be discreetly removed from the retail outlet displays and concealed from the check out clerk by a shoplifter leaving the store without paying. An important proportion of retail stores operate on very small margins, and thus a shrink rate of even a small percentage, for example 2% of the value of all sales for a given period, can significantly affect the bottom line.

### OBJECT OF THE INVENTION

The gist of the invention is thus to provide means to further control the problem associated with shoplifting of small but relatively expensive commercial goods in retail stores.

### SUMMARY OF THE INVENTION

In view of the object of the invention, there is disclosed a shoplifting deterrent system for use in commercial retail stores, said system comprising:—a cabinet unit, defining a main wall having an access mouth opening into an enclosure, said enclosure for receiving a stack of superimposed commercial articles for sale;—a drawer, including a front door, sized for closing said access mouth in a closed condition of said drawer, and a slider base panel, transversely rearwardly extending from said door integrally thereto, said slider panel for supporting a single commercial article from the stack thereof and for enabling withdrawal of this single commercial article from said cabinet unit once said drawer reaches an extended open condition;—retaining means, slidingly interconnecting said slider base panel against a portion of said cabinet unit peripheral wall and positioning said door in register with said access mouth;—a fore and aft extending stricker pad, anchored to said cabinet unit, said pad having a knurled surface area; and—a clicker spring member, transversely anchored to said slider panel and defining a free end tongue, said clicker spring member being positioned so that said free end tongue thereof frictionally engages a portion of said pad knurled surface area; wherein upon said drawer being manually pulled outwardly from said cabinet unit, a loud noise is generated by said clicker spring member free end tongue scraping said pad knurled surface area.

At least a few additional ones of said cabinet unit and said drawer may be added, each with an associated said clicker spring member, said retaining member and said stricker pad, and a bracket mount assembly operatively serially interconnecting all of such cabinet units. Said bracket mount assembly could include means for anchoring all of said cabinet units to an upright wall spacedly over ground.

Said retaining means could consist of a pair of elbowed flanges, integrally projecting from said cabinet unit main wall, each of said flanges defining a lip spacedly extending over said a portion of said cabinet unit main wall, wherein a channel is defined between each said lip and a registering portion of said cabinet unit main wall, each of said channel slidingly engaged by opposite side edge portions of said slider panel.

Preferably, biasing means are provided to continuously bias said drawer to its said closed condition. In one embodiment, said biasing means would include a reel member, a mount rotatably mounted to said cabinet unit main wall, and an elongated spring band being spring-loaded in winded condition around said reel member and having an inner end anchored to said reel member and an outer end anchored to said drawer slider.

Said clicker spring member free end tongue is preferably curved by half a turn, to form an arcuate tongue.

In one embodiment, said knurled surface consists of a succession of concave grooves.

The shoplifting deterrent system may also further include:—a gate member,—slider mount means mounting said gate member to said cabinet unit main wall above adjacent said access mouth for displacement of said gate member between a first limit position, clearing said access mouth, and a second position, partially closing said access mouth,—locking means releasably locking said gate member into a selected one of said first position and said second position, wherein only one commercial article at a time can pass through said access mouth when said drawer is extended outwardly from said cabinet unit in said open condition thereof.

The invention also relates to a sound alert device for use with a drawer extendible from a cabinet unit, said sound alert device constituting sound cue means that the drawer is extended from the cabinet unit, said sound alert device comprising:—a deformable elastic member having an intermediate section, an inner end portion and an outer end portion, both said inner end portion and outer end portion integral to said intermediate section, said outer end portion forming a free stricker end tongue;—an anchor member, for anchoring to a portion of the drawer, said inner end portion of said elastic member being anchored to said anchor member; and—an anvil member, for anchoring to a portion of the cabinet unit, said anvil member having an uneven anvil surface, said anvil member being located relative to said anchor member in such a fashion that said elastic member free stricker end tongue continuously frictionally engages said uneven anvil surface; wherein a clicker spring noise is generated from scraping action of said stricker end tongue against said uneven anvil surface upon the drawer being extended from the cabinet unit.

Said uneven anvil surface may be knurled, for example made from a plurality of successive concave grooves made into said anvil member, said concave grooves extending in a direction transverse to that of said stricker end tongue.

Said stricker end tongue could form a smooth surfaced convex bulge.

### DESCRIPTION OF THE DRAWINGS

In the annexed drawings:

FIG. 1 is a perspective partial view of a set of plurality of interconnected display cases;

FIG. 2 is a partly sectional, partly broken, front elevational view, at an enlarged scale, of a left hand side portion of the set of display cases of FIG. 1;

FIG. 3 is a partly broken, lateral side end view, at an enlarged scale, of the left hand end portion of the set of display cases of FIG. 1, suggesting in phantom lines how a display case door can be opened from its closed condition shown in full lines;

FIG. 4 is a cross-sectional view taken alone line IV-IV of FIG. 2, showing in phantom lines a stack of superimposed commercial articles for sale inside the display case housing;

FIG. 5 is a sectional view taken along line V-V of FIG. 4;

FIGS. 6 and 7 are bottom plan views of one display case from the set of display cases of FIG. 1, at a scale similar to that of FIG. 4 or 5, and sequentially showing how the drawer thereof can be opened and how the clicker/spring travels along concurrently therewith; and

FIG. 8 is a partial, exploded, partly broken perspective view of the anchoring bracket mount at one end of the display case set of FIG. 1.

### DETAILED DESCRIPTION OF THE EMBODIMENTS

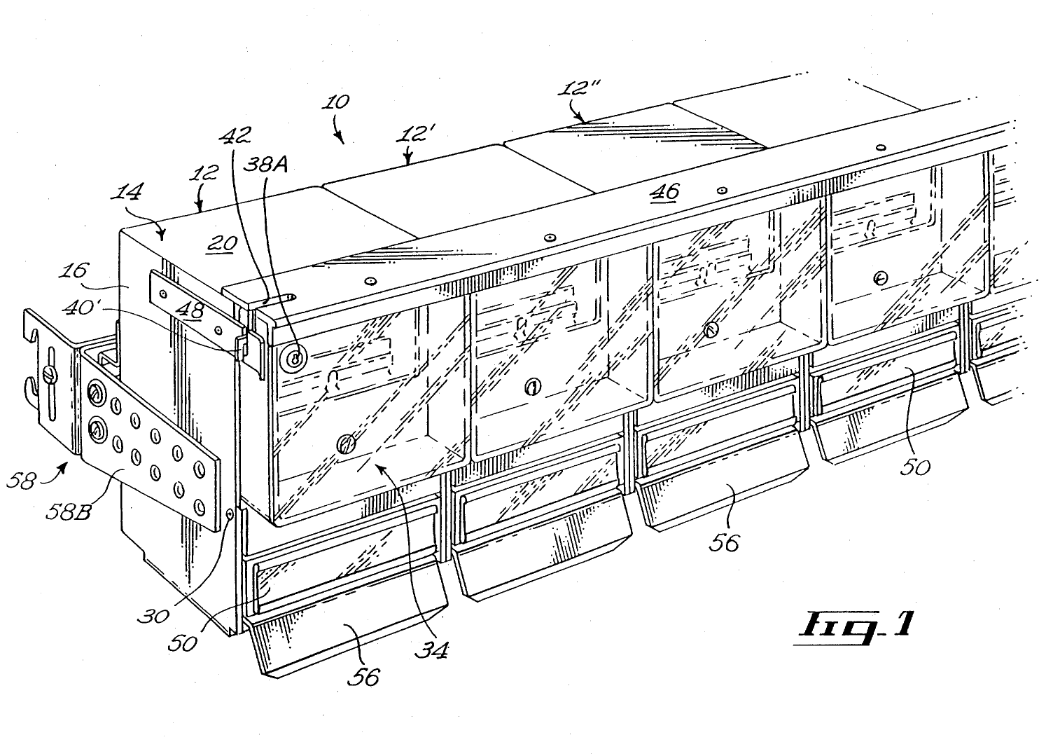

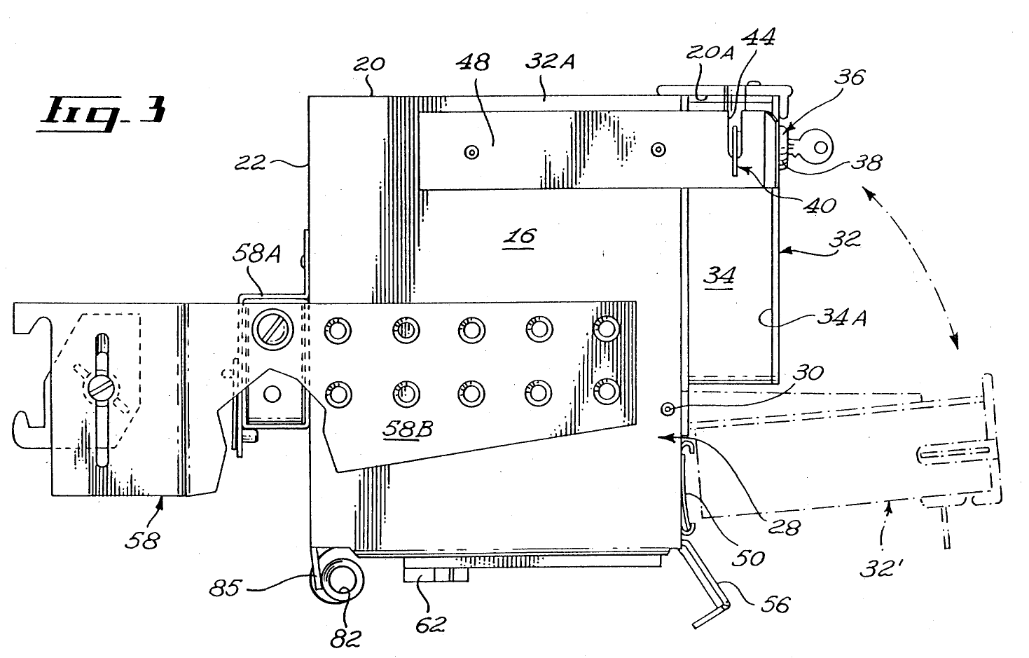

An assembly of display case units is shown as 10 in FIGS. 1-4. Each display unit 12, 12′, 12″, . . . is of a make similar to the other ones. Display unit 12 includes a box-like container 14, having a pair of opposite lateral side walls 16, 18, a top wall 20, a back wall 22, a flooring 24 for supporting inside the thus formed enclosure 26 at least a few commercial identical goods G, G′, G″, G′″, . . . in superimposed fashion, and a front open access mouth 28. Enclosure 26 is sized to freely receive a superimposed stack of goods G, G′, . . . in manually fed fashion through access mouth 28. Flooring 24 includes an intermediate window 24A extending forwardly from back wall 22 to a point short of the plane intersecting front access mouth 28. Hinge mounts 30, 30, hingedly mount a door 32 to intermediate front edge portions of lateral side walls 16, 18, for pivotal motion between a first limit closed condition, illustrated as 32 in full lines in FIG. 3, in which door 32 closes the upper portion of access mouth 28, and a second opened condition, illustrated as 32′ in phantom lines in FIG. 3, in which door 32 clears the upper portion of access mouth 28.

Door 32 preferably has a sealed front subcompartment 34, with a frontmost transparent panel portion 34A. Subcompartment 34 is destined to accommodate a single commercial item display, not shown, to show off and enable a customer to readily inspect one example of the plurality of commercial goods on sale inside the container 14.

A lock member 36 releasably interlocks the top end portion of door 32 to the upper edge portions of lateral side walls 16, 18, to prevent unauthorized access into enclosure 26. Lock member 36 may include for example a barrel 38 with a front axial keyslot 38A, and with an integral rear transverse tab 40 pivotally movable between an upright position (not shown), engaging a registering corner slot 42 made in the front portion 20A of top wall 20, and a horizontal position 40′, shown in FIGS. 1 and 3, having released slot 42 but engaged another corner slot 44 made into the upper lateral side edge portion 32A of door 32. Wall front portion 20A and door side edge portion 32A may each be reinforced by integral reinforcement strips 46, 48, respectively.

Box like container 14 and door 32 are made from rigid sheet material, for example, rigid PVC sheets. Transparent door panel 32A is made for example of transparent plastic. Reinforcement strips 46, 48, and lock barrel 38 are made from a stronger material, e.g. a metallic alloy.

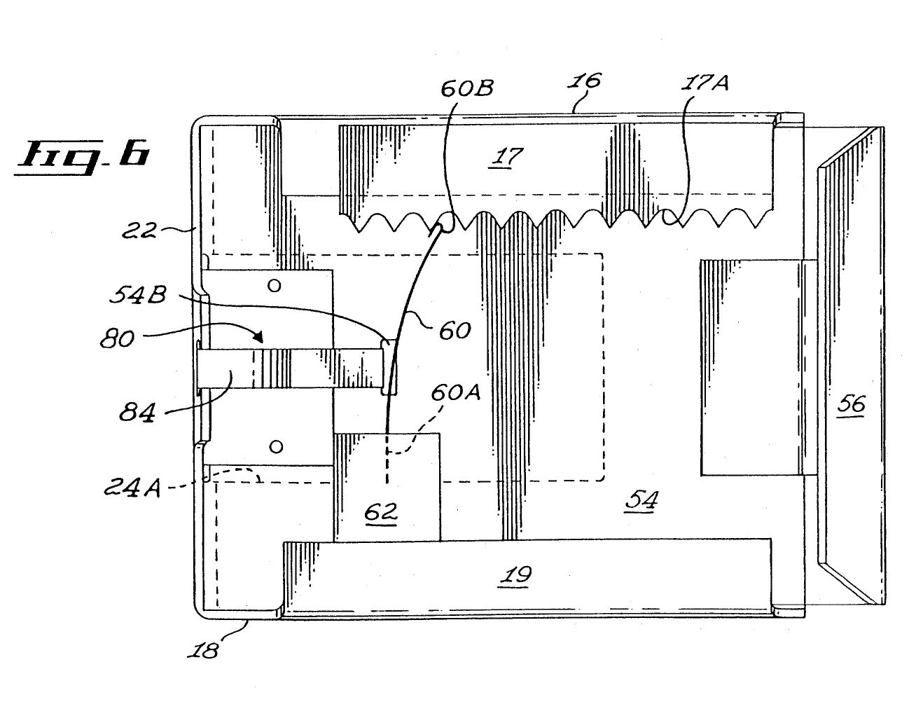

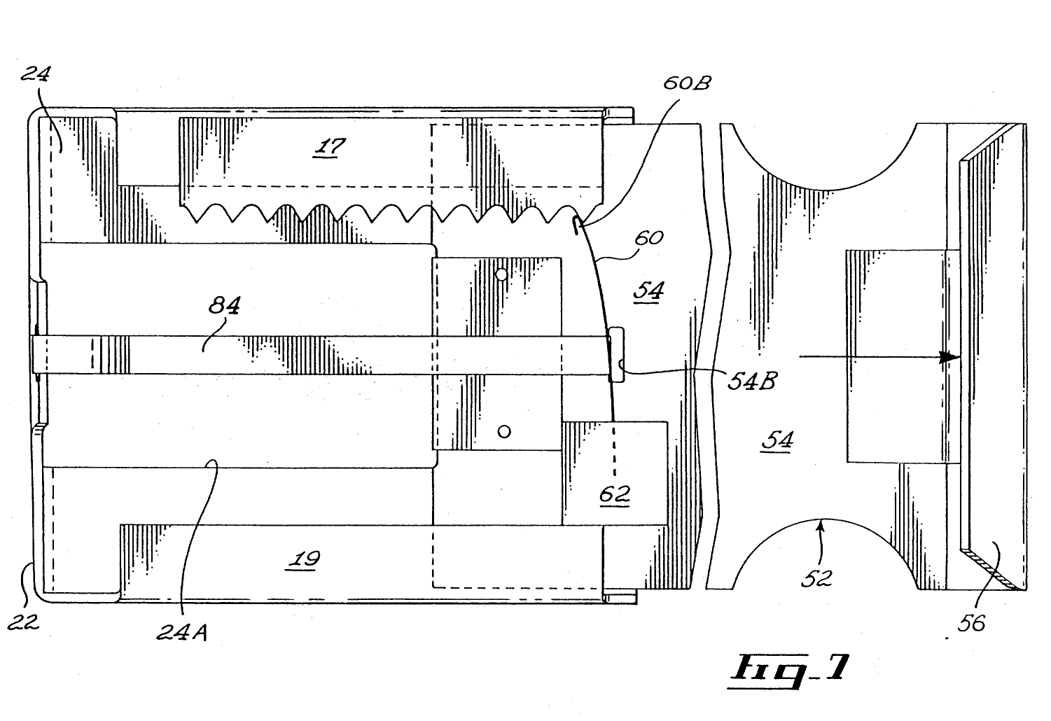

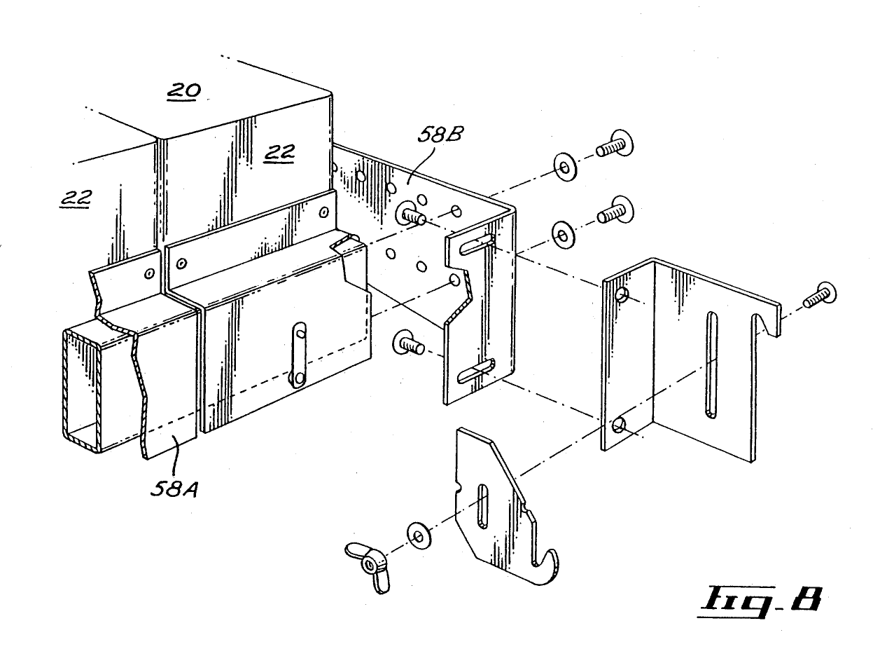

A drawer 5′ (FIGS. 6-7) is provided for sliding engagement beneath flooring 24, and to releasably close a lower free window 28A of front access mouth 28 below door 32. An identification socket 50 forms the front wall of drawer 52. The purpose of socket 50 is for releasably receiving and retaining a paper or cardboard identification sheet (not illustrated), in the known fashion, for providing the usual commercial information about the product offered for sale: type, unit price, etc. . . . Drawer 52 further includes a floor or base panel 54 slidingly retained against the underface of the main display unit casing flooring 24 by inturned flanges 17, 19. These flanges 17, 19, transversely project toward one another from the bottom edges of side walls 16, 18. The rear end of floor panel 54 includes an integral, central transverse tab 54A, extending upwardly through and beyond the flooring window 24A. The purpose of transverse tab 54 is that, during opening of the drawer 52, tab 54 will hook a commercial good specimen G (the lowermost of the stack) standing on flooring 24, and will bias forwardly this good specimen G away from back wall 22, through and beyond passageway 28A to slide and fall from main casing flooring 24 to the opened drawer base panel 54. A customer may then grasp and retrieve the selected specimen G from drawer 52, since the drawer base panel 54 projects outwardly from cabinet 14. This will also allow the next in line good specimen G′ from the stack to fall down onto flooring 24, since the originally selected good G has to be replaced.

The inner edge of flange 17 facing opposite flange 19, at 17A, is knurled, for a purpose later set forth. The knurling of knurled inner flange edge 17A is preferably, as shown in FIG. 6, a succession of concave, transverse grooves in a non-sinusoidal pattern; however, inner flange edge 17A could be of any other irregular shape, not excluding a wavy surface, or even simply a coarse grade planar material surface.

A frontwardly downwardly inclined elbowed handle 56 may be provided to the bottom edge of identification socket 50, to facilitate handling (pulling) of drawer 52 relative to the main unit container 14.

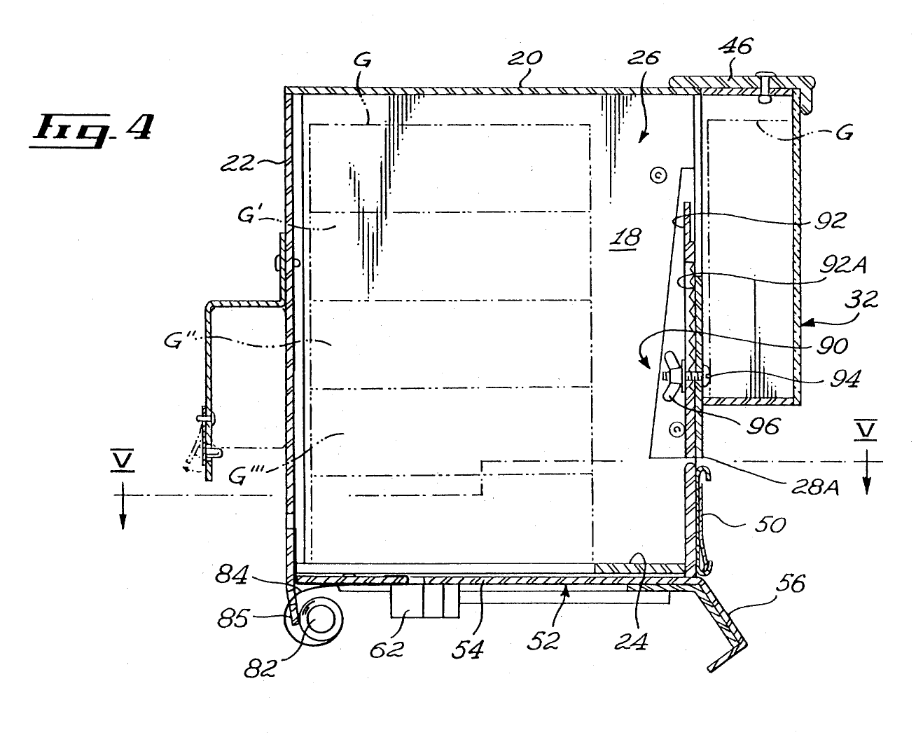

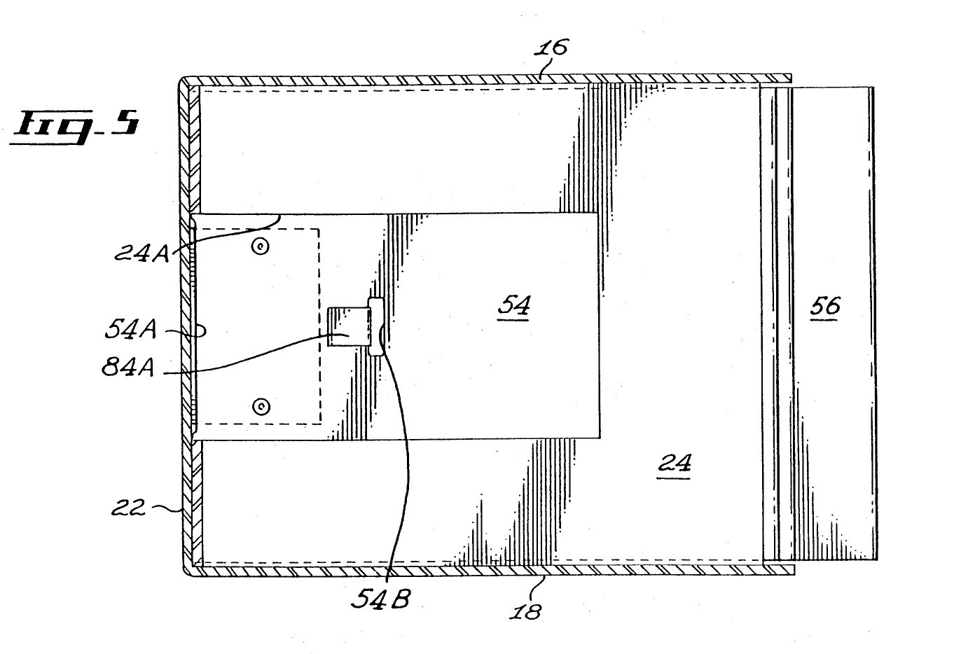

Beneath subcompartment 32, there is thus formed a passageway 28A (FIG. 4) sized in height and width to enable passage of only one commercial good G at a time, i.e. the good G at the bottom of the stack of goods G, G′, . . . inside enclosure 26. When drawer 52 is closed (FIG. 4), panel 50 extends through and closes passageway 28A. However, when drawer 52 is opened (FIG. 7), panel 50 releases passageway 28A so that one specimen of good G may pass from enclosure 26 to the outside for grasping by a customer and retrieval thereof.

Preferably, adjustment means 90 (FIG. 4) are provided to adjust the height of lower passageway 28A, to take into account the specific size of the type of specimen of good. Adjustment means 90 may for example include a gate 92, slidingly carried against the back wall 34B of subcompartment 34. Gate 92 may for example include a slit 92A, through which slidingly engages a bolt 94 projecting transversely from back wall 34B. A wing nut 96 enables the operator to tighten bolt 94, and thus, to frictionally lock gate 92 at a selected height relative to flooring 24, to partially close window 28A conformingly with the required size of commercial good G that needs to pass through passageway 28A, only one at a time.

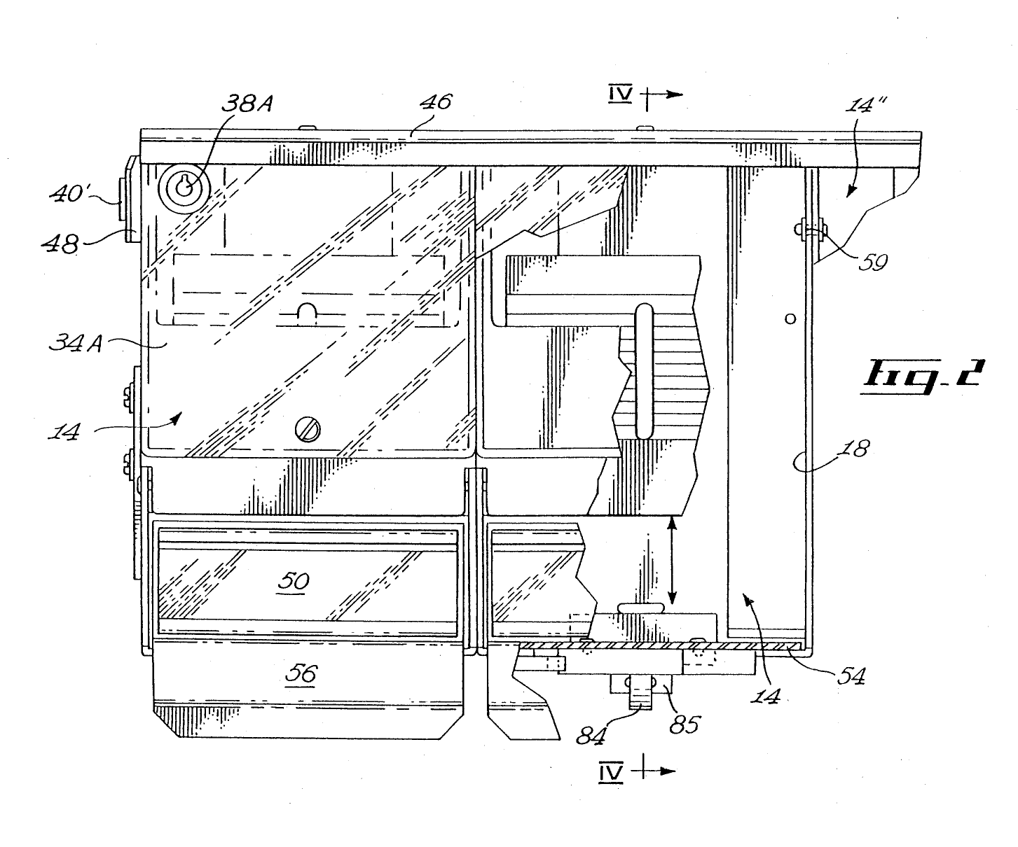

A number of containers 14, 14′, 14″, . . . may be serially interconnected, as shown in FIG. 1, by a U-shape bracket 58 having a web 58A, anchored to each of the back walls 22 of all box-like containers 14, and two opposite short legs 58B, 58B, anchored to the two exposed lateral side walls 16, 18, of the opposite ends containers 14, 14. Each pair of adjacent containers 14, 14, are also preferably anchored to one another by their facing adjacent side walls 16, 18, by rivets 59 (FIG. 2). Bracket 58 may be for example of the type enabling anchoring of the assembly of display case units, 10, to an upright building wall, spacedly over ground.

As best shown in FIGS. 6 and 7, an elongated but relatively narrow metallic leaf spring 60 may be anchored at one end 60A to an anchor block 62 fixedly connected to the underface of one rear corner portion of drawer panel 54, proximate slide flange 19. The leaf spring 60, which may be for example rectangular, further includes a free outer end tongue 60B. Preferably, outer end tongue 60B is curved to form a half a turn arcuate tongue. Leaf spring 60 is sized so that arcuate tongue 60B remains in frictional engagement transversely with knurled surface 17A of slide flange 17. As the drawer panel 54 is pulled slidingly along slider rails 17, 19, away from back wall 22, the arcuate tongue 60B of leaf spring slides along the knurled surface 17A of flange 17, gliding through the concave troughs but jumping from one trough to the next successive one. As the leaf spring arcuate tongue 60B jumps from one trough to the next one, a clearly audible clicking noise is generated, as the leaf spring 60 is elastically deformed in the process. As such, the leaf spring 60 thus act as a clicker/spring mechanism. Thus, such repeated clicking noise constitutes a clue to the store clerk that the drawer 52 has been opened.

Preferably, and as best shown in FIGS. 4, 6 and 7 of the drawings, there is provided biasing means 80 to continuously bias drawer 52 towards its closed condition illustrated in FIG. 4. Biasing means 80 may include for example a reel 82 with an elongated metallic leaf spring-loaded strip 84 wound therearound, the reel 82 rotatably mounted at mount 85 to the bottom edge portion of back wall 22. Leaf strip 84 is anchored at its inner end to reel 82, and also anchored at its outer end to the rear edge portion of drawer 54, for example by forming a permanent short loop 84A through a small aperture 54B made at the rear edge portion of drawer 54. Since leaf strip 84 is spring-loaded, there is continuous bias applied by strip 84 about reel 82 to wind the reel 82 fully.

1. A shoplifting deterrent system for use in commercial retail stores, said system comprising:
a cabinet unit, defining a main wall having an access mouth opening into an enclosure, said enclosure for receiving a stack of superimposed commercial articles for sale;
a drawer, including a front door, sized for closing said access mouth in a closed condition of said drawer, and a slider base panel, transversely rearwardly extending from said door integrally thereto, said slider panel for supporting a single commercial article from the stack thereof and for enabling withdrawal of this single commercial article from said cabinet unit once said drawer reaches an extended open condition;
retaining means, slidingly interconnecting said slider base panel against a portion of said cabinet unit peripheral wall and positioning said door in register with said access mouth;
a fore and aft extending stricker pad, anchored to said cabinet unit, said pad having a knurled surface area; and
a clicker spring member, transversely anchored to said slider panel and defining a free end tongue, said clicker spring member being positioned so that said free end tongue thereof frictionally engages a portion of said pad knurled surface area;
wherein upon said drawer being manually pulled outwardly from said cabinet unit, a loud noise is generated by said clicker spring member free end tongue scraping said pad knurled surface area.

2. A shoplifting deterrent system as in claim 1,
further including at least a few additional ones of said cabinet unit and said drawer, each with an associated said clicker spring member, said retaining member and said stricker pad, and a bracket mount assembly operatively serially interconnecting all of such cabinet units.

3. A shoplifting deterrent system as in claim 2,
wherein said bracket mount assembly includes means for anchoring all of said cabinet units to an upright wall spacedly over ground.

4. A shoplifting deterrent system as in claim 1,
wherein said retaining means consists of a pair of elbowed flanges, integrally projecting from said cabinet unit main wall, each of said flanges defining a lip spacedly extending over said a portion of said cabinet unit main wall, wherein a channel is defined between each said lip and a registering portion of said cabinet unit main wall, each of said channel slidingly engaged by opposite side edge portions of said slider panel.

5. A shoplifting deterrent system as in claim 1,
further including biasing means, continuously biasing said drawer to its, said closed condition.

6. A shoplifting deterrent system as in claim 5,
wherein said biasing means includes a reel member, a mount rotatably mounted to said cabinet unit main wall, and an elongated spring band being spring-loaded in winded condition around said reel member and having an inner end anchored to said reel member and an outer end anchored to said drawer slider.

7. A sholifting deterrent system as in claim 1,
wherein said clicker spring member free end tongue is curved by half a turn, to form an arcuate tongue.

8. A shoplifting deterrent system as in claim 7,
wherein said knurled surface consists of a succession of concave grooves.

9. A shoplifting deterrent system as in claim 1,
further including:
a gate member,
slider mount means mounting said gate member to said cabinet unit main wall above adjacent said access mouth for displacement of said gate member between a first limit position, clearing said access mouth, and a second position, partially closing said access mouth,
locking means releasably locking said gate member into a selected one of said first position and said second position, wherein only one commercial article at a time can pass through said access mouth when said drawer is extended outwardly from said cabinet unit in said open condition thereof.

10. A sound alert device for use with a drawer extendible from a cabinet unit, said sound alert device constituting sound cue means that the drawer is extended from the cabinet unit, said sound alert device comprising:
a deformable elastic member having an intermediate section, an inner end portion and an outer end portion, both said inner end portion and outer end portion integral to said intermediate section, said outer end portion forming a free stricker end tongue;
an anchor member, for anchoring to a portion of the drawer, said inner end portion of said elastic member being anchored to said anchor member; and
an anvil member, for anchoring to a portion of the cabinet unit, said anvil member having an uneven anvil surface, said anvil member being located relative to said anchor member in such a fashion that said elastic member free stricker end tongue continuously frictionally engages said uneven anvil surface;
wherein a clicker spring noise is generated from scraping action of said stricker end tongue against said uneven anvil surface upon the drawer being extended from the cabinet unit.

11. A sound alert device as defined in claim 10,
wherein said uneven anvil surface is knurled.

12. A sound alert device as defined in 11,
wherein said uneven anvil surface is made from a plurality of successive concave grooves made into said anvil member, said concave grooves extending in a direction transverse to that of said stricker end tongue.

13. A sound alert device as defined in claim 12,
wherein said stricker end tongue forms a smooth surfaced convex bulge.

14. In combination, a drawer for mounting into and extendible from a cabinet unit, and a sound alert device, said drawer including a base panel and a front panel transverse to said base panel, said sound alert device constituting sound cue means that the drawer is extended from the cabinet unit, said sound alert device comprising:
a deformable elastic member having an intermediate section, an inner end portion and an outer end portion, both said inner end portion and outer end portion integral to said intermediate section, said outer end portion forming a free stricker end tongue;
an anchor member, being anchored to said base panel of said drawer, said inner end portion of said elastic member being anchored to said anchor member; and
an anvil member, for anchoring to a portion of the cabinet unit, said anvil member having an uneven anvil surface, said anvil member being located relative to said anchor member in such a fashion that said elastic member free stricker end tongue continuously frictionally engages said uneven anvil surface;
wherein a clicker spring noise is generated from scraping action of said stricker end tongue against said uneven anvil surface upon said drawer being extended from the cabinet unit.

15. A sound alert device as defined in claim 14,
wherein said uneven anvil surface is knurled.

16. A sound alert device as defined in 15,
wherein said uneven anvil surface is made from a plurality of successive concave grooves made into said anvil member, said concave grooves extending in a direction transverse to that of said stricker end tongue.

17. A sound alert device as defined in claim 16,
wherein said stricker end tongue forms a smooth surfaced convex bulge.
